(19) United States
(12) Patent Application Publication
(10) Pub. No.: US 2025/0271047 A1
(43) Pub. Date: Aug. 28, 2025

(54) CRASH STRUCTURE FOR A VEHICLE

(71) Applicant: Carbon Truck & Trailer GmbH, Buxtehude (DE)

(72) Inventors: Gerret KALKOFFEN, Hamburg (DE); Hauke KÜHL, Hamburg (DE)

(73) Assignee: Carbon Truck & Trailer GmbH, Buxtehude (DE)

(21) Appl. No.: 18/859,657

(22) PCT Filed: Apr. 25, 2023
(86) PCT No.: PCT/EP2023/060780

§ 371 Date: Oct. 24, 2024

(30) Foreign Application Priority Data
Apr. 25, 2022 (DE) 20 2022 102 210.0

(51) Int. Cl. F16F 7/12; B60R 19/18; B62D 29/00

(52) U.S. Cl. CPC F16F 7/124; F16F 7/121; B60R 19/18; B60R 2019/186; B62D 29/001; F16F 2224/0225; F16F 2224/0241; F16F 2226/042; F16F 2236/04

(57) ABSTRACT

An energy-absorbing element to absorb kinetic energy in the event of an impact. The energy-absorbing element can improv energy absorption in the event of an impact or collision of a component or motor vehicle. The energy-absorbing elements has fiber composites for shock absorption and the fiber longitudinal direction is predominantly parallel to or at an acute angel in the direction of the impact. Smaller absorption elements are produced and joined as the longitudinal direction of the final component does not coincide with the production direction to allow for a simple production process.

### TECHICAL FIELD

The invention relates to an energy-absorbing element, for example to absorb kinetic energy in the event of an impact.

### BACKGROUND ART

The installation of energy-absorbing elements in motor vehicles to protect people in the vehicle from injury is known from prior art.

The side sill, for example, serves this purpose. The optimization of the side sill using elements located inside it is also known from prior art. For example, DE 10 2017 123 400 A1 describes the incorporation of hollow components running in the longitudinal direction of the side sill into the side sill. Other forms of inserts are also known, for example from DE 10 2019 208 224 A1 or DE 10 2014 012 082 A1.

DE 10 2021 001 103 A1 also describes the wrapping of extruded metallic profiles with fiber composite material in order to partially fill a cavity between extruded profile and side sill. In this case the wrapped extruded profiles are incorporated into the side sill so that their longitudinal extension runs parallel to that of the side sill.

It is common practice to refer to the intended straight-ahead direction of a motor vehicle as the X direction and the transverse or lateral directions as the y direction, whereby the y direction is usually assumed to run from the outside of the vehicle to the center for each component and the z direction is considered to be the vertical upward direction when driving straight ahead. Derived from this, the corresponding designation of the directions on the non-installed component itself has also become established, as the installation orientation of the parts is generally clearly determined.

The orientation of the + or − direction of an axis is considered insignificant for components that are symmetrical to a plane.

The object of the invention is to achieve improved energy absorption in the event of an impact or collision of the component or motor vehicle. The inventor has established that conventional components for impact absorption, such as bumpers, side sills or

A/B/C pillars, have an elongated design with a significantly greater extension in their longitudinal direction than in the directions perpendicular thereto. The components are thereby usually arranged or designed to be arranged in such a way that the longitudinal direction is perpendicular to most of the forces acting in the event of an impact or collision. In addition, the elements are usually designed so that they are manufactured in a production process that produces them longitudinally and/or homogeneously, for example by extrusion or by cutting sheet metal to size. The inventor has furthermore discovered that it is advantageous to use fiber composites for shock absorption whose fiber longitudinal direction is predominantly parallel to or at an acute angle to the direction of impact. As impacts are generally expected to occur at an acute angle, in particular approximately at right angles, to the longitudinal direction of these components, as has also been confirmed in crash tests such as the 75° pole crash according to UN R135 or the 90° “side barrier” crash test according to UN R95, it has proved to be advantageous that longitudinal fiber directions in an angle range of −30° to +30° to the vertical of the longitudinal direction and in particular in an angle range of −30° to +30° to the horizontal direction are advantageous. It is not important here that all fibers run in this direction.

In order to be able to guarantee this with a simple production process, smaller absorption elements are advantageously produced and joined, as the longitudinal direction of the final component does not coincide with the production direction. The absorption elements are therefore joined in particular perpendicularly to their production direction, in particular by gluing.

### SUMMARY OF THE INVENTION

The object is achieved in particular by an impact absorber for absorbing forces in the event of an impact by crushing and/or by at least partial plastic deformation, comprising a plurality-meaning at least three-of connected, in particular bonded, profiles, in particular hollow components, in particular hollow profiles. This also includes flat profiles, whereby prismatic profiles and/or non-flat profiles are particularly favored. In particular, the profiles have walls in more than one plane. The profiles are made of fiber-reinforced plastic, in particular with glass, plant and/or carbon fibers. The profiles are positioned apart from one another, at least in sections, and form intermediate spaces, in particular cavities and/or hollow chambers. The intermediate spaces can be formed both by the individual profiles or between them. The profiles each extend in at least two mutually perpendicular spatial directions, whereby their extension in a first spatial direction is greater than in all other spatial directions.

The profiles are advantageously firmly connected to one another over their entire elongation in a second spatial direction perpendicular to the first spatial direction in a plurality of connecting areas, which are distributed over the extension in the first spatial direction, with neighboring connecting areas in the first spatial direction having a maximum spacing of 200 mm. The connecting areas can also be directly adjacent to one another and thus also be formed by a continuous connection, such as in a sandwich arrangement. The connection can be made by thin connections, in which the profiles come directly together apart from a thin joining layer, for example of adhesive, but also by thicker connecting layers, such as in a sandwich arrangement with alternating layers each of a profile with foam firmly connected to the profiles, in particular by means of elastic and/or plastically deformable and/or brittle foam. Intermediate layers can also be used, as would be the case, for example, if a foam layer were bonded with profiles on both sides or if intermediate inserts, for example also made of fiber-reinforced plastic, were inserted between two profiles, for example to achieve a greater spacing, and bonded to both profiles in each case. In particular, the distance between the profiles in the connecting areas is less than 50 mm, more particularly less than 5 mm.

The fiber-reinforced plastic has fibers with one longitudinal direction, i.e. in particular fibers that have a greater extension in one direction than in the directions perpendicular to it.

The longitudinal fiber directions of at least 30% w/w, in particular more than 50% w/W, of the fibers of the fiber-reinforced plastic run in at least one angle in the range from −30° to +30°, in particular from −20° to +20°, in particular parallel to the second spatial direction.

The object is achieved by an impact absorber group consisting of a plurality of impact absorbers according to the invention that are connected, in particular bonded, to each other, in particular directly adjacent to each other,
a) wherein the volumetric centers of gravity of the intermediate spaces, in particular cavities and/or hollow chambers, of the impact absorbers are arranged relative to one another in at least one translatory direction, which can be formed from one or two directions perpendicular to the common direction and the common direction by means of linear combination, in which the proportion of the common direction is not equal to zero, in particular is at least 5%, and/or
b) wherein the volumetric centers of gravity of the intermediate spaces, in particular cavities and/or hollow chambers, of the impact absorbers are arranged relative to one another in at least one translatory direction, which can be formed from one or two directions perpendicular to the common direction and the common direction by means of linear combination, wherein the plurality of impact absorbers is formed from impact absorbers with different forms and/or mechanical properties, in particular different wall thicknesses and/or cavity and/or hollow chamber sizes and/or shapes, and/or
c) wherein at least one axis of symmetry of an intermediate space, in particular a cavity and/or a hollow chamber, of a first impact absorber of the impact absorber group encloses an angle in the range from greater than 0° to 60°, in particular in the range from 3 to 45°, in particular from 4 to 30°, to at least one axis of symmetry of an intermediate space, in particular a cavity and/or a hollow chamber, of a second impact absorber of the impact absorber group, wherein this applies in particular to all intermediate spaces of the first and second impact absorber and/or all axes of symmetry of the intermediate spaces.

The joining of the impact absorbers allows several objectives to be achieved. Firstly, the aim of orienting the longitudinal direction of the fibers and simple production in a continuous process with simple feeding of the fibers can be achieved. Secondly, the combination of different impact absorbers allows the properties of the group to be designed locally differently in all spatial directions. This not only allows a desired temporal progression of the energy absorption to be set, for example by joining different absorbers together in the y direction or in the horizontal direction, particularly in the second spatial direction, but also a different absorption and shaping to be achieved at different points, for example in the x or z direction. In addition, an oblique cut when cutting the profiles, i.e. in particular cutting at an angle that deviates from 90° and 0° to the production direction and/or if at least two edges of a profile are not parallel and/or not at right angles, these can be used to create a shape that deviates from the elongated shape when joining the absorbers.

The object is achieved by an impact absorber arrangement, in particular a hollow bodywork component, in particular metallic, in particular a body pillar, sill, roof frame, body profile and/or front or rear bumper for and/or of a motor vehicle, having at least one impact absorber or an impact absorber group arranged in a hollow chamber profile or an element forming a cavity, in particular a hollow bodywork component, wherein the hollow chamber and/or the cavity has a longitudinal extension that is greater than its extension in the spatial directions perpendicular thereto. Advantageously, the common directions of the parallel-plane groups of the impact absorbers are arranged at least one angle in the range from 60 to 120° and/or from −60 to −120°, in particular in the range from 80 to 100° or −80 to −100°, to the longitudinal extension of the hollow chamber profile or the cavity in which they are arranged.

By incorporating them into such a component, the properties of the various elements and/or materials can be combined and a particularly advantageous effect achieved, for example if the body pillar, sill, front or rear bumper for and/or of a motor vehicle are made of metal.

The object is also achieved by a motor vehicle, in particular a land vehicle, motor vehicle, in particular a land vehicle, in particular having at least four wheels, having at least one impact absorber, one impact absorber group and/or impact absorber arrangement, in which, when arranged laterally and substantially horizontally, in particular when the longitudinal extension is arranged at an angle in the range from −15° to +15° relative to the horizontal direction in the vehicle, the first spatial direction encloses an angle in the range from −30° to +30° with the forward straight-ahead direction of the vehicle, in particular corresponds to this, and/or in the case of a lateral and essentially vertical arrangement, in particular when the longitudinal extension is arranged at an angle in the range from −15° to +15° to the vertical, the first spatial direction in the vehicle encloses an angle in the range from −30° to +30° with the forward straight-ahead direction of the vehicle, in particular corresponds to this, and/or when arranged in the front or rear of the vehicle, the first spatial direction forms an angle in the range from −60° to 120° and/or in the range from −60° to −120° with the forward straight-ahead direction of the vehicle, in particular perpendicular to this.

The object is also achieved by a method for producing an, in particular inventive, impact absorber in which at least three profile sections of fiber composite material are produced by means of a continuous production process, in particular by means of pultrusion, having a production direction, so that the longitudinal fiber directions of at least 30% w/w, in particular more than 50% w/w, of the fibers of the fiber-reinforced plastic run at at least one angle in the range from −30° to +30° to the production direction and in which the profiles are arranged perpendicular to the production direction next to and/or on top of one another and are firmly connected to one another, in particular in such a way that the smallest extension of each profile lies in the direction of the arrangement of the profiles (in particular in z direction) and the profiles are spaced apart from one another at least in sections, and in which the profiles form intermediate spaces, in particular cavities and/or hollow chambers. Advantageously, the fixed connections are made in a plurality of connecting areas, distributed over the extension in the first spatial direction, wherein neighboring connecting areas in the first spatial direction have a maximum spacing of 200 mm.

The method also advantageously comprises joining several impact absorbers together to form an impact absorber group, in particular by means of adhesive and/or, in particular, by means of plastically and/or elastically deformable and/or brittle foam.

The method also advantageously comprises joining the impact absorber group with an element to form an impact absorber arrangement.

Compared with purely metallic tubular elements, the use of fiber-reinforced plastic offers a more homogeneous and/or more constant force-displacement curve, which can also be adapted very precisely through the use and, in particular, the combination of different absorbers.

Advantageously, the fixed connection is produced by the profiles, intermediate layer profiles, adhesive, honeycombs, for example made of aramid, and/or foam, in particular elastically and/or plastically deformable and/or brittle foam. For this purpose, the profiles can, for example, run towards each other at the connecting area and/or, in particular, adjacent thereto or have alignments towards each other and be bonded together in the connecting areas.

Particularly advantageously, an impact absorber, in which the first spatial direction to the x direction encloses an angle in the range from 30 to +30° and/or the second spatial direction to the y direction encloses an angle in the range from −30 to +30° and/or in which the profiles are manufactured in a continuous production process and in particular represent sections of the continuously manufactured workpiece and in particular the y direction encloses an angle in the range from −30 to +30° to the manufacturing direction of the profile.

The profiles are preferably each composed of mutually adjacent walls, the walls lying in and/or tangentially on at least two parallel plane groups, which in each case enclose an angle in the range from 60 to 120° and/or from −60° to −120° to at least one other of the at least two parallel plane groups, wherein preferably the connected profiles, together or jointly, form cavities and/or hollow chamber profiles which enclose them in at least four spatial directions (e.g. in the direction +x, −x, +z, −z) and/or in which the mutually adjacent walls lie in and/or tangentially on in each case one of the planes of the at least two parallel plane groups which enclose an angle in the range from 60 to 120° or from −60 to −120° relative to one another. In particular, the walls are flat and/or have a constant wall thickness, apart from a transition area to the adjacent wall, which is in particular curved.

This enables a particularly good absorption effect to be achieved with a low weight.

Advantageously, the longitudinal directions of the fibers of the fiber-reinforced plastic are arranged with at least 30% by weight of the fibers at at least one angle in the range from −30° to +30° to a direction common to the at least two parallel plane groups and/or running in the same direction, and that the cavities and/or hollow chambers are arranged next to one another in at least one translatory direction that can be formed from one or two directions perpendicular to the common direction by means of linear combination.

The intermediate spaces, in particular the cavities and/or hollow chambers, are preferably completely or partially filled with foam, in particular elastically and/or plastically deformable and/or brittle foam, and/or honeycombs, for example made of aramid, aramid paper, plastic and/or aluminum, and/or the profiles are coated and/or sheathed on at least one side, in particular on one side or the outside, in particular on two, three or four sides, with solid foam, in particular elastically and/or plastically deformable foam. This allows a particularly favourable absorption to be achieved.

With particular advantage, the profiles have a constant cross-section over their extension in the second spatial direction. This facilitates production, particularly in continuous production, from whose products profiles are then cut.

The wall thicknesses of the profiles are preferably in the range of 0.5 mm to 15 mm and/or the extensions in the first spatial direction are in the range of 50-3000 mm and/or the profiles have an extension in the spatial direction perpendicular to the first and second spatial directions in the range of 30 mm to 500 mm. This allows particularly good absorption properties to be achieved and material can also be saved.

Advantageously, the impact absorber and/or the impact absorber group can have materials on the outside that expand and/or harden when exposed to heat. This makes it easy to achieve a firm connection, localized fixation and/or filling of the element when it is arranged, for example, in a tubular element.

The impact absorber group is particularly preferably formed from a plurality of impact absorbers with different designs, for example shapes and/or dimensions, and/or different mechanical properties, in particular caused by different wall thicknesses and/or cavity and/or hollow chamber sizes and/or shapes and/or profile geometries. For example, angled geometries of the group can be easily and reliably achieved with good absorption properties by cutting the profiles at an angle to the production direction.

The impact absorber group advantageously has an extension perpendicular to the first and second spatial direction or in the z direction in the range of 30 to 500 mm.

Preferably, the common directions of the parallel plane groups of the impact absorbers, in particular all of them, have at least one, in particular all of them each having one, angle to the y direction in the range from −30 to 30°, in particular −20 to 20°.

Advantageously, the impact absorbers are and/or the impact absorber assembly is locally fixed in and/or connected to the element by means of material expanded and/or hardened under the effect of heat and/or an intermediate space between the element and the impact absorber and/or impact absorber assembly is partially or completely filled with such a material. Advantageously, the impact absorbers are and/or the impact absorber assembly is locally fixed in and/or connected to the element by means of material that expands and/or hardens under the effect of heat and/or an intermediate space between the element and the impact absorber and/or impact absorber assembly is partially or completely filled with such a material.

In particular, foams with a specific compressive strength in the range of 0.1 to 20 MPa and/or polymer foams, in particular polyurethane, PVC, PET, XPS foams and/or metal foams, in particular aluminum foams, are used.

Surrounding or backing the impact absorber group with a further component, for example a plate, in particular made of metal and/or fiber-reinforced plastic, can help to increase energy absorption, support the reaction forces occurring during the collision and absorb secondary loads (e.g. in the x direction).

The local provision of foams, adhesives or similar, which foam/swell and harden at temperature, can be used to firmly bond the component composite to the body shell during the temperature post-treatment of a cathodic dip coating.

Further possible embodiments and advantages are explained below purely by way of example using some simplified figures. The coordinate systems shown in some figures are intended to illustrate the alignment of the illustrated elements in the vehicle.

### BRIEF DESCRIPTION OF THE DRAWINGS

FIG. 1 is a still separate illustration of two prismatic profiles with wall in two horizontal planes each and in vertical y-z planes with adhesive in between.

FIG. 2a is a first illustration or section of an impact absorber in sandwich construction.

FIG. 2b is a second illustration or section of an impact absorber in sandwich construction.

FIG. 2c is a third illustration or section of an impact absorber in sandwich construction.

FIG. 2d is a fourth illustration or section of an impact absorber in sandwich construction.

FIG. 3a is a first exemplary illustration of a sandwich-like arrangement with foam layers.

FIG. 3b is a second exemplary illustration of a sandwich-like arrangement with foam layers.

FIG. 3c is a third exemplary illustration of a sandwich-like arrangement with foam layers.

FIG. 4 is an exemplary illustration of various combinations of different impact absorbers as an impact absorber group.

FIG. 5 is an exemplary illustration of cross-sections through three different impact absorber arrangements.

FIG. 6 is an exemplary illustration of a longitudinal section through a side sill with an angled shape.

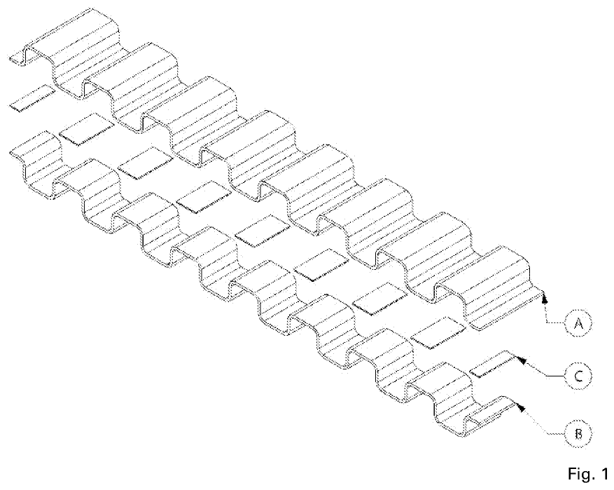

FIG. 1 shows a still separate illustration of two prismatic profiles (A, B) with walls in two horizontal planes each and in vertical y-z planes with adhesive (C) in between. The sections of the profiles facing each other in the horizontal planes are now bonded to the spacer plates on both sides over their entire length in the y-direction. The profiles thus create hollow chambers, namely between the connecting areas.

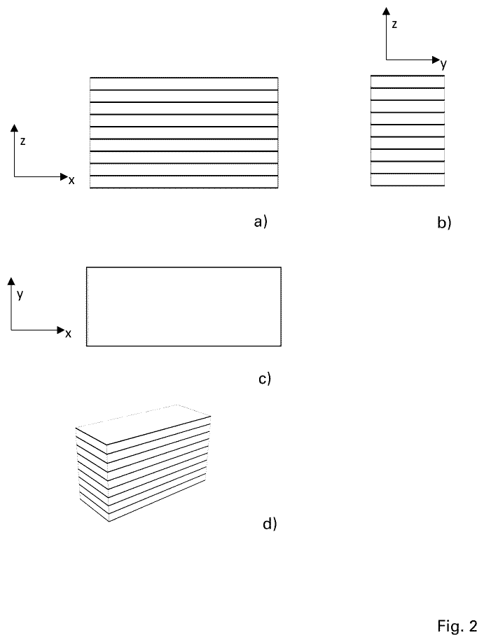

FIG. 2 shows several illustrations or sections of an impact absorber in sandwich construction with flat profiles shown as dark lines and brittle plastic foam arranged in between that is firmly connected to a profile on both sides.

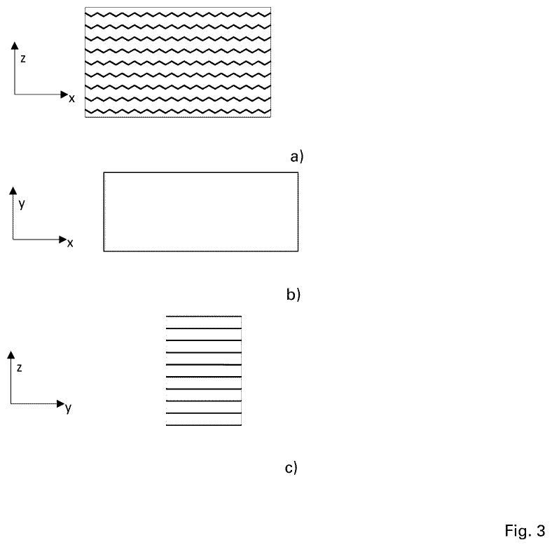

FIG. 3 also shows a sandwich-like arrangement with foam layers, but the profiles each have a zigzag course and thus walls in two parallel plane groups.

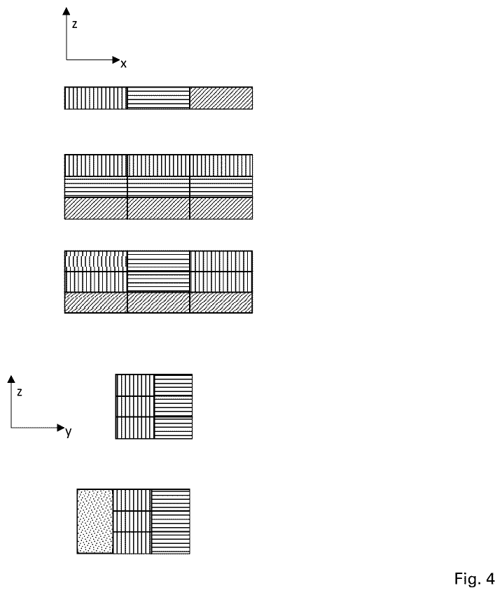

FIG. 4 shows various combinations of different impact absorbers as an impact absorber group. The lines of the hatching do not represent the profiles, but merely symbolize different impact absorbers that have different properties, for example different wall thicknesses of the profiles used in them. The top illustration shows an arrangement with different impact absorbers arranged one behind the other in the x direction. Below this, an arrangement with three identical absorbers in the x direction is shown, with three different impact absorbers arranged in the z direction. Below this, an arrangement is shown with different impact absorbers in the y direction. The same arrangement is shown at the bottom, but with brittle plastic foam (shown with dots) on the left.

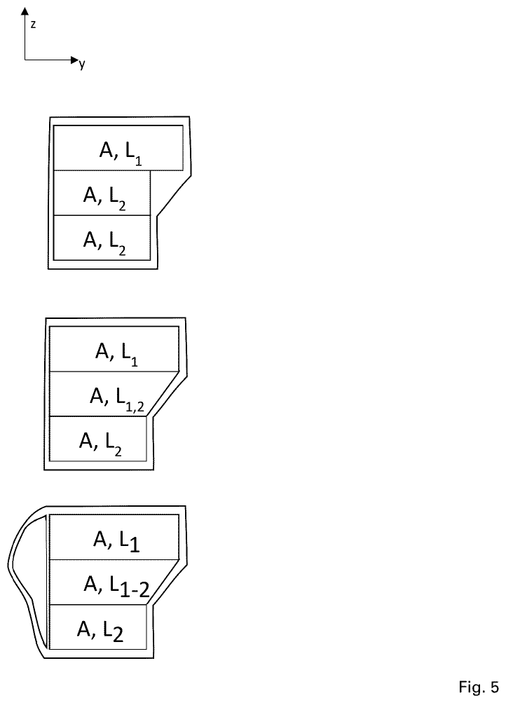

FIG. 5 shows cross-sections through three different impact absorber arrangements. In each case, different impact absorbers are combined in the z direction to form an impact absorber arrangement, each of which is arranged in a metal side sill. The impact absorbers have different extensions in the y direction and different geometries in cross-section. It can be seen that a more precise filling can be achieved than when using identical elements. In the bottom illustration, foam (to the left of the impact absorbers) was also used to fill the sill even better and/or to influence the absorption curve.

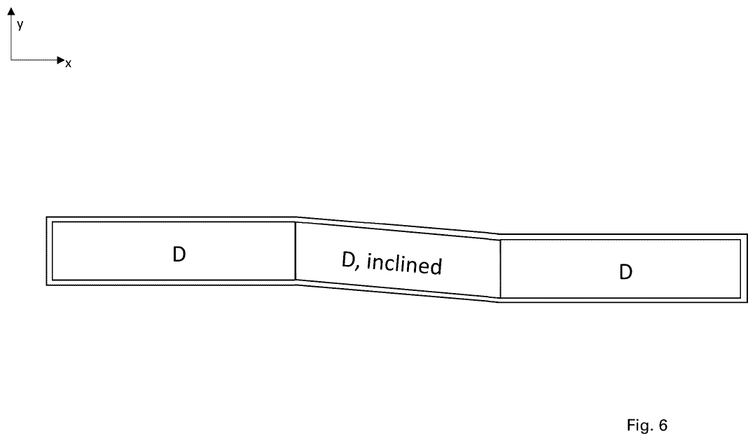

FIG. 6 shows a longitudinal section through a side sill with an angled shape. An impact absorber group is arranged in it, with impact absorbers (D) with the same properties, but of which the center one has been cut at an angle on both sides, resulting in a contour adapted to the shape of the side sill.

1. An impact absorber for absorbing forces during an impact by crushing or at least partial plastic deformation, comprising:
a plurality of connected profiles;
wherein each of the plurality of connected profiles are made of fiber-reinforced plastic and said profiles being spaced apart from one another at least in sections;
wherein at least one intermediate space is formed by the plurality of connected profiles;
wherein each of the plurality of connected profiles extend in at least two mutually perpendicular spatial directions and the extension of each of the plurality of connected profiles are greater in a first spatial direction than in all other spatial directions;
wherein each of the plurality of connected profiles are firmly connected to one another;
wherein at least one adjacent connecting area in the first spatial direction have a maximum spacing of 200 mm and longitudinal fiber directions of at least 30% w/w of at least one fiber of the fiber-reinforced plastic extend in at least one angle in the range from −30° to +30° to a spatial direction perpendicular to the first spatial direction.

2. The impact absorber according to claim 1, wherein each of the plurality of connected profiles are firmly connected to one another so that a firm connection is produced by each one of the plurality of connected profiles or between each one of the plurality of connected profiles by at least one intermediate layer profiles, adhesive, honeycomb or solid foam.

3. The impact absorber according to claim 1, wherein the first spatial direction encloses an angle in the range from −30 to +30° with respect to the x direction or the second spatial direction encloses an angle in the range from −30 to +30° with respect to the y direction.

4. The impact absorber according to claim 1, wherein each one of the plurality of connected profiles are produced in a continuous manufacturing process.

5. The impact absorber according to claim 1, wherein the each one of the plurality of connected profiles are composed of mutually adjacent walls, said walls lying in or tangentially on at least two parallel plane groups, which in each case enclose an angle in the range from 60 to 120° or from −60° to −120° to at least one other of the at least two parallel plane groups, with the connected profiles, together or jointly, forming cavities or hollow chamber profiles which enclose them in at least four spatial directions and in which the mutually adjacent walls lie in or tangentially on in each case one of the planes of the at least two parallel plane groups which enclose an angle in the range from 60 to 120° or from −60 to −120° relative to one another.

6. The impact absorber according to claim 1, wherein at least one longitudinal direction of the at least one fiber of the fiber-reinforced plastic are arranged with at least 30% by weight of the at least one fiber of at least one angle in the range from −30° to +30° to a direction common to the at least two parallel plane groups or running in the same direction, and that the cavities or hollow chambers are arranged next to one another in at least one translatory direction that can be formed from one or two directions perpendicular to the common direction by means of linear combination.

7. The impact absorber according to claim 6, wherein the cavities or hollow chambers are completely or partially filled with foam or honeycombs or the profiles are coated or sheathed on at least one side with foam.

8. The impact absorber according to claim 1, wherein each one of the plurality of connected profiles have a constant cross-section over their extension in the second spatial direction.

9. The impact absorber according claim 5, wherein the wall thicknesses of each one of the plurality of connected profiles are in the range of 0.5 mm to 15 mm or the extensions in the first spatial direction are in the range of 50-3000 mm or each one of the plurality of connected profiles have an extension in the spatial direction perpendicular to the first and second spatial directions in the range of 30 mm to 500 mm.

10. An impact absorber group comprising:
a plurality of impact absorbers
wherein each one of the plurality of impact absorbers comprises:
a plurality of connected profiles;
wherein each of the plurality of connected profiles are made of fiber-reinforced plastic and said profiles being spaced apart from one another at least in sections;
wherein at least one intermediate space is formed by the plurality of connected profiles;
wherein each of the plurality of connected profiles extend in at least two mutually perpendicular spatial directions and the extension of each of the plurality of connected profiles are greater in a first spatial direction than in all other spatial directions;
wherein each of the plurality of connected profiles are firmly connected to one another;
wherein at least one adjacent connecting area in the first spatial direction have a maximum spacing of 200 mm and longitudinal fiber directions of at least 30% w/w of at least one fiber of the fiber-reinforced plastic extend in at least one angle in the range from −30° to +30° to a spatial direction perpendicular to the first spatial direction;
wherein each one of the plurality of impact absorbers are connected to one another, with each one of the plurality of connected profiles each being made of mutually adjoining walls, said walls lying in or tangentially on at least two parallel plane groups;
a) in which a volumetric center of gravity of the intermediate space of each one of the plurality of impact absorbers are arranged relative to one another in at least one translatory direction, which can be formed from one or two directions perpendicular to the common direction with one of the two parallel plane groups and the common direction can be formed by means of linear combination, in which the proportion of the common direction is not equal to zero or
b) in which the volumetric center of gravity of the intermediate space of each one of the plurality of impact absorbers are arranged relative to one another in at least one translatory direction, which can be formed from one or two directions perpendicular to the common direction and the common direction by means of linear combination, wherein the plurality of impact absorbers is formed from impact absorbers with different forms or mechanical properties or
c) in which at least one axis of symmetry of the intermediate space, of a first impact absorber of the impact absorber group encloses an angle in the range from greater than 0° to 45° to at least one axis of symmetry of an intermediate space of a second impact absorber of the impact absorber group, wherein this applies to all intermediate spaces of the first and second impact absorber or all axes of symmetry of the intermediate spaces.

11. The impact absorber group according to claim 10, wherein the plurality of impact absorbers is formed from impact absorbers with different forms or mechanical properties.

12. The impact absorber group according claim 10, wherein the impact absorber group has an extension perpendicular to the first and second direction or in the z direction in the range from 30 to 500 mm.

13. An impact absorber arrangement comprising:
at least one impact absorber comprising:
plurality of connected profiles;
wherein each of the plurality of connected profiles are made of fiber-reinforced plastic and said profiles being spaced apart from one another at least in sections;
wherein at least one intermediate space is formed by the plurality of connected profiles;
wherein each of the plurality of connected profiles extend in at least two mutually perpendicular spatial directions and the extension of each of the plurality of connected profiles are greater in a first spatial direction than in all other spatial directions;
wherein each of the plurality of connected profiles are;
wherein at least one adjacent connecting area in the first spatial direction have a maximum spacing of 200 mm and longitudinal fiber directions of at least 30% w/w of at least one fiber of the fiber-reinforced plastic extend in at least one angle in the range from −30° to +30° to a spatial direction perpendicular to the first spatial direction;
or an impact absorber group according to one of the preceding claims comprising:
a plurality of impact absorbers;
wherein each one of the plurality of impact absorbers comprises:
a plurality of connected profiles;
wherein each of the plurality of connected profiles are made of fiber-reinforced plastic and said profiles being spaced apart from one another at least in sections;
wherein at least one intermediate space is formed by the plurality of connected profiles;
wherein each of the plurality of connected profiles extend in at least two mutually perpendicular spatial directions and the extension of each of the plurality of connected profiles are greater in a first spatial direction than in all other spatial directions;
wherein each of the plurality of connected profiles are firmly connected to one another;
wherein at least one adjacent connecting area in the first spatial direction have a maximum spacing of 200 mm and longitudinal fiber directions of at least 30% w/w of at least one fiber of the fiber-reinforced plastic extend in at least one angle in the range from −30° to +30° to a spatial direction perpendicular to the first spatial direction;
wherein each one of the plurality of impact absorbers are connected to one another, with each one of the plurality of connected profiles each being made of mutually adjoining walls, said walls lying in or tangentially on at least two parallel plane groups;
a) in which a volumetric center of gravity of an intermediate space of each one of the plurality of impact absorbers are arranged relative to one another in at least one translatory direction, which can be formed from one or two directions perpendicular to the common direction with one of the two parallel plane groups and the common direction can be formed by means of linear combination, in which the proportion of the common direction is not equal to zero or
b) in which the volumetric center of gravity of the intermediate space of each one of the plurality of impact absorbers are arranged relative to one another in at least one translatory direction, which can be formed from one or two directions perpendicular to the common direction and the common direction by means of linear combination, wherein the plurality of impact absorbers is formed from impact absorbers with different forms or mechanical properties or
c) in which at least one axis of symmetry of the intermediate space of a first impact absorber of the impact absorber group encloses an angle in the range from greater than 0° to 45° to at least one axis of symmetry of an intermediate space of a second impact absorber of the impact absorber group, wherein this applies to all intermediate spaces of the first and second impact absorber or all axes of symmetry of the intermediate spaces;
wherein the at least one impact absorber or the impact absorber group are arranged in a hollow chamber profile or an element forming a cavity, in which the hollow chamber of the hollow chamber profile or the cavity has a longitudinal extension which is greater than its extension in the spatial directions perpendicular thereto with the walls lying in or tangentially to at least two parallel plane groups and in which the common directions of the parallel plane groups of the impact absorbers are at least at an angle in the range from −60 to 120° or from −60 to −120° to the longitudinal extension of the hollow chamber profile or the cavity in which they are arranged.

14. The impact absorber arrangement according to claim 13, wherein the common directions of the parallel plane groups of the impact absorbers have at least one angle in the range from −30 to 30° to the y direction or a horizontal direction.

15. (canceled)

16. An impact absorber for absorbing forces in the event of an impact due to crushing or at least partial plastic deformation with walls in more than one plate, comprising:
a fiber-reinforced plastic;
wherein the fiber-reinforced plastic includes class, plant or carbon fibers;
wherein the impact absorber extending in at least two mutually perpendicular spatial directions;
wherein the extension of the impact absorber in the first spatial direction is greater than in all other spatial directions; and
wherein the longitudinal direction of the fiber of the fiber-reinforced plastic are of at least 30% by weight of the fibers run in at least one angle in the range from −30° to +30° to a spatial direction perpendicular to the first spatial direction.

17. The impact absorber according to claim 16, wherein the longitudinal direction of the fiber of the fiber-reinforced plastic of at least 30% by weight of the fibers run in at least one angle in the range from −30° to +30° to a horizontal direction.

18. The impact absorber according to claim 16, wherein the impact absorber is hollow.

19. The impact absorber according to claim 16, wherein the impact absorber consists of a plurality of absorption elements which are joined together perpendicular to their production direction.
